(19) United States
(12) Patent Application Publication
(10) Pub. No.: US 2015/0343848 A1
(43) Pub. Date: Dec. 3, 2015

(54) HEAVY-DUTY PNEUMATIC TIRE

(71) Applicant: SUMITOMO RUBBER INDUSTRIES LTD., Kobe-shi (JP)

(72) Inventor: Masakazu WASHIZUKA, Kobe-shi (JP)

(73) Assignee: SUMITOMO RUBBER INDUSTRIES LTD., Kobe-shi (JP)

(21) Appl. No.: 14/723,752

(22) Filed: May 28, 2015

(30) Foreign Application Priority Data
May 28, 2014 (JP) 2014-110472

(51) Int. Cl. B60C 11/04; B60C 11/12; B60C 5/00

(52) U.S. Cl. CPC B60C 11/04; B60C 5/00; B60C 11/12

(57) ABSTRACT

A heavy-duty pneumatic tire includes a tread having main grooves and lateral grooves connecting the main grooves such that each main groove has zigzag pattern extending continuously in tire circumferential direction and that the lateral grooves divide portion between the main grooves into blocks. Each main groove has a groove periphery on block side such that the groove periphery has inward crests protruding toward the block side and outward crests protruding in the opposite direction and alternating with the inward crests, the lateral grooves connect the inward crests and incline at angle α in range of 10 to 20 degrees with respect to tire axial direction, and each block is formed to have a ground-contact surface which has substantially hexagonal shape and ratio W2/W1 in range of 0.85 to 0.95 where W2 represents tire axial minimum width and W1 represents tire axial maximum width in the ground-contact surface.

### CROSS-REFERENCE TO RELATED APPLICATIONS

The present application is based upon and claims the benefit of priority to Japanese Patent Application No. 2014-110472, filed May 28, 2014, the entire contents of which are incorporated herein by reference.

### BACKGROUND OF THE INVENTION

1. Field of the Invention

The present invention relates to a heavy-duty pneumatic tire capable of suppressing noise.

2. Description of Background Art

JP2010-95196A describes a heavy-duty pneumatic tire which has a tread section that includes multiple main grooves extending in a zigzag pattern and multiple lateral grooves connecting the main grooves while inclining with respect to a tire axial direction so that multiple blocks are formed between the main grooves. The groove periphery of each main groove on the block side alternately includes an inward crest protruding toward a block and an outward crest protruding in the opposite direction from the block. Each lateral groove extends to connect the outward crests of the main grooves. The tire axial width of each block enlarges toward both sides of the tire in a circumferential direction. The entire contents of this publication are incorporated herein by reference.

### SUMMARY OF THE INVENTION

According to one aspect of the present invention, a heavy-duty pneumatic tire includes a tread having main grooves and lateral grooves connecting the main grooves such that each of the main grooves has a zigzag pattern extending continuously in a tire circumferential direction and that the lateral grooves divide a portion between the main grooves into blocks. Each of the main grooves has a groove periphery on a block side such that the groove periphery has inward crests protruding toward the block side and outward crests protruding in the opposite direction of the blocks and alternating with the inward crests, the lateral grooves connect the inward crests and incline at an angle α in a range of 10 to 20 degrees with respect to a tire axial direction, and each of the blocks is formed to have a ground-contact surface which has substantially a hexagonal shape and a ratio (W2/W1) in a range of 0.85 to 0.95 where W2 represents the tire axial minimum width and W1 represents the tire axial maximum width in the ground-contact surface.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a developed view of a tread section according to an embodiment of the present invention;

FIG. 2 is a partially enlarged view showing the vicinity of the crown land portion in FIG. 1; and

FIG. 3 is a cross-sectional view taken at B-B in FIG. 2.

### DETAILED DESCRIPTION OF THE EMBODIMENTS

The embodiments will now be described with reference to the accompanying drawings, wherein like reference numerals designate corresponding or identical elements throughout the various drawings.

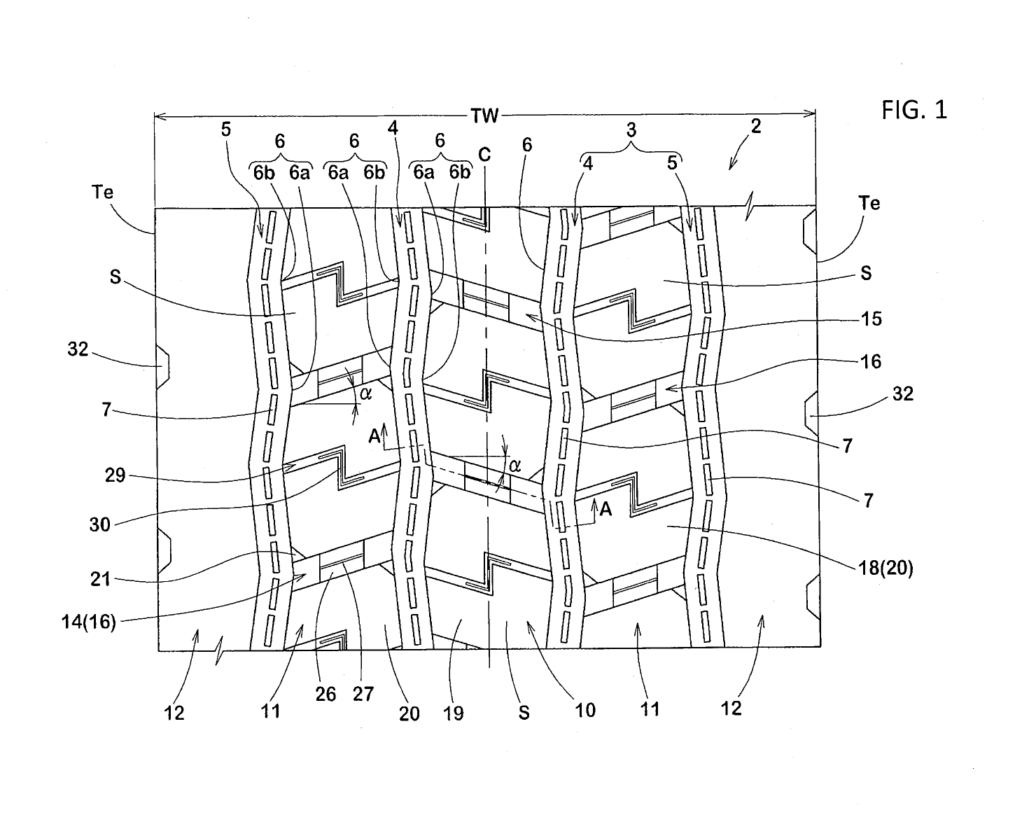

FIG. 1 is a developed view showing tread section 2 of a heavy-duty pneumatic tire of the present embodiments (hereinafter may also be referred to simply as a “tire”). As shown in FIG. 1, at least two main grooves 3 are formed in tread section 2. Main groove 3 is formed to drain water, and is preferred to have a groove width in a range of 2˜7% of tread width (TW), for example.

Main grooves 3 include a pair of crown main grooves (4; 4) respectively extending along both sides of tire equator (C) and a pair of middle main grooves (5, 5) each extending on the tire axially outer side of a crown main groove 4. Crown main groove 4 and middle main groove 5 extend in a zigzag pattern continuously in a circumferential direction of the tire. In a preferred embodiment, protrusions 7 raised from the groove bottom to prevent stone biting are formed in crown main groove 4 or middle main groove 5.

Because of crown main groove 4 and middle main groove 5, tread section 2 is divided into crown land portion 10 between crown main grooves (4, 4), middle land portion 11 between crown main groove 4 and middle main groove 5, and shoulder land portion 12 between middle main groove 5 and tread edge (Te).

A “tread edge” is the axially outermost position when a tire makes contact with a planar ground surface at a camber angle of zero degrees under normal conditions with a normal load applied thereon. The distance between tread edges (Te, Te) in a tire axial direction is tread width (TW).

“Normal conditions” indicate a state in which a tire is mounted on a normal rim (not shown) and filled with air to have a normal inflation pressure with no load applied thereon. In the present application, measurements of a tire are those obtained under normal conditions unless otherwise specified.

A “normal rim” indicates a rim regulated by a regulatory system that includes standards for the tire: for example, it is specified as a “Normal Rim” by JATMA; “Design Rim” by TRA; and “Measuring Rim” by ETRTO.

“Normal inflation pressure” indicates air pressure regulated by a regulatory system that includes standards for the tire: for example, it is specified as “Maximum Air Pressure” by JATMA, maximum value listed in a table “Tire Load Limits at Various Cold Inflation Pressures” by TRA, and “Inflation Pressure” by ETRTO.

“Normal load” indicates a load regulated by a regulatory system that includes standards for the tire: for example, it is specified as “Maximum Load Capacity” by JATMA, maximum value listed in the table “Tire Load Limits at Various Cold Inflation Pressures” by TRA, and “Load Capacity” by ETRTO.

Multiple crown lateral grooves 15, for example, are formed in crown land portion 10. Accordingly, crown land portion 10 is divided into multiple crown blocks 19. In the same manner, multiple middle lateral grooves 16, for example, are formed in middle land portion 11. Accordingly, middle land portion 11 is divided into multiple middle blocks 20. On the other hand, no lateral groove is formed to completely cross shoulder land portion 12. As a result, shoulder land portion 12 is a rib formed continuously in a circumferential direction of the tire.

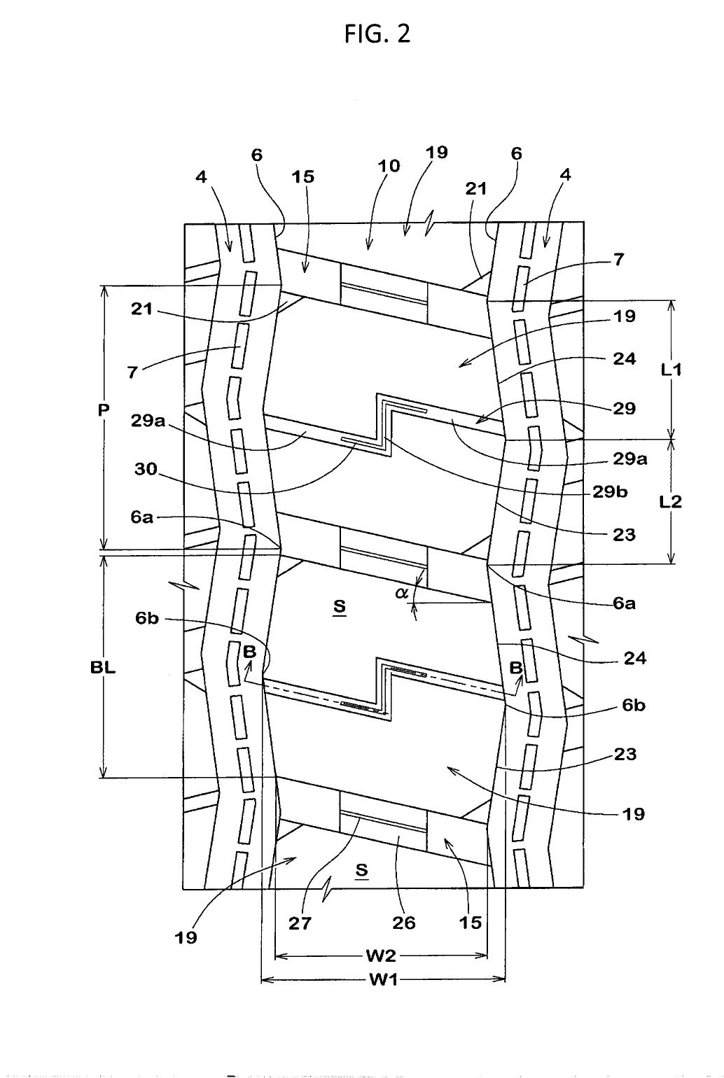

FIG. 2 is a partially enlarged view showing the vicinity of crown land portion 10 shown in FIG. 1. As shown in FIG. 1 or 2, in each crown main groove 4, inward crest (6a) protruding into crown block 19 and outward crest (6b) protruding in the opposite direction of crown block 19 are alternately formed along groove periphery 6 on the crown block 19 side. Crown lateral groove 15 extends as a straight line to connect inward crests (6a). By so setting, the ground-contact surface (S) of crown block 19 is formed to be approximately hexagonal.

The tire axial width of such a crown block 19 decreases toward both sides in a circumferential direction of the tire, and its rigidity is low on both edges in a circumferential direction of the tire. Accordingly, when each crown block 19 makes contact with the ground, impact noise generated at both of its edges is suppressed. On the other hand, each crown block 19 has greater rigidity in its central portion than at both edges in a circumferential direction. Such a setting reduces deformation that occurs from the beginning through the end of ground contact. Accordingly, crown block 19 exhibits excellent traction performance and rolling resistance.

Moreover, crown lateral groove 15 is formed to incline at an angle (α) in a range of 10˜20 degrees with respect to a tire axial direction. Thus, when the tire is running, the timing of ground contact is staggered for both edges of crown block 19. Such a setting is effective for dispersing impact noise to further reduce the sound pressure level while certainly suppressing excessive deformation at both edges of crown block 19 when they touch the ground.

When angle (α) of crown lateral groove 15 is smaller than 10 degrees, impact noise may not be lowered sufficiently. On the other hand, when angle (α) is greater than 20 degrees, that causes greater deformation at both edges of crown block 19, and sufficient traction performance may not be achieved.

In a preferred embodiment, crown lateral groove 15 is provided with shallow-bottom portion 26 raised from the groove bottom. Shallow-bottom portion 26 is formed only in the longitudinal central portion of crown lateral groove 15. Since shallow-bottom portion 26 connects crown blocks 19 adjacent to each other in a tire circumferential direction, it works to even more effectively reduce deformation at both edges when crown block 19 makes contact with the ground.

In a further preferred embodiment, lateral-groove sipe 27 is formed in shallow-bottom portion 26 to extend in a longitudinal direction of crown lateral groove 15. Lateral-groove sipe 27 works to keep the circumferential rigidity of crown block 19 from increasing too much because of shallow-bottom portion 26, for example.

In addition, tire axial minimum width (W2) and tire axial maximum width (W1) of ground-contact surface (S) of each crown block 19 are set to have a ratio (W2/W1) in a range of 0.85˜0.95. Such a setting further suppresses deformation when crown block 19 makes contact with the ground, thereby further improving traction performance and rolling resistance. That is, when a ratio (W2/W1) is greater than 0.95, the rigidity balance in crown block 19 decreases, which in turn may degrade traction performance and rolling resistance. On the other hand, when a ratio (W2/W1) is less than 0.85, corner portions on both sides in a tire axial direction make acute angles, causing greater deformation of the portions. Thus, the crown block may wear unevenly. To securely prevent uneven wear, sloped beveled portion 21 is formed at a corner of crown block 19 where ground-contact surface (S) makes an acute angle.

In ground-contact surface (S) of each crown block 19 of the present embodiment, tire axial maximum width (W1) and tire circumferential length (BL) are preferred to have a ratio (W1/BL) in a range of 0.85˜0.95. When a ratio (W1/BL) is outside the above range, the rigidity balance of crown block 19 decreases, and traction performance and rolling resistance may thereby be degraded. When tire circumferential length (BL) of ground-contact surface (S) varies in a tire axial direction, the maximum tire circumferential length is used as tire circumferential length (BL).

To maintain traction and excellent water drainage using crown lateral groove 15 when the tire travels straight, tire circumferential length (BL) of ground-contact surface (S) of crown block 19 is preferred to be 0.80 to 0.90 times the zigzag pitch (P) of groove periphery 6 of crown main groove 4.

Groove periphery 6 of crown main groove 4 includes first inclined piece 23 extending between an outward crest (6b) and inward crest (6a) on one side as well as second inclined piece 24 extending between the outward crest (6b) and inward crest (6a) on the other side. Tire circumferential length (L1) of first inclined piece 23 and tire circumferential length (L2) of second inclined piece 24 are preferred to have a ratio (L1/L2) in a range of 0.9˜1.03, for example. Because of such crown block 19, even better traction performance and rolling resistance are achieved

In a preferred embodiment, crown block 19 is provided with thin groove 29 which completely crosses ground-contact surface (S). Thin groove 29 works to reduce the rigidity of crown block 19 and enhance wear resistance, while it is effective for improving water drainage. The groove width of thin groove 29 is preferred to be 2.0˜4.0 mm, for example.

Both ends of thin groove 29 are each preferred to be connected to outward crest (6b) or its vicinity of crown main groove 4. When such a thin groove 29 is formed, crown block 19 is capable of maintaining rigidity in axial directions while mitigating rigidity in circumferential directions.

In an even more preferred embodiment, thin groove 29 is formed in an approximate Z shape that bends to have two corners, for example. Thin groove 29 of the present embodiment has a pair of outer portions (29a, 29a) extending from crown main groove 4 in a longitudinal direction of crown lateral groove 15 and one inner portion (29b) connecting outer portions (29a, 29a). Inner portion (29b) extends in a tire circumferential direction. Such thin groove 29 works to mitigate the rigidity of crown block 19 while suppressing significant deformation when the tire turns or the like by alternately engaging block pieces divided by thin groove 29.

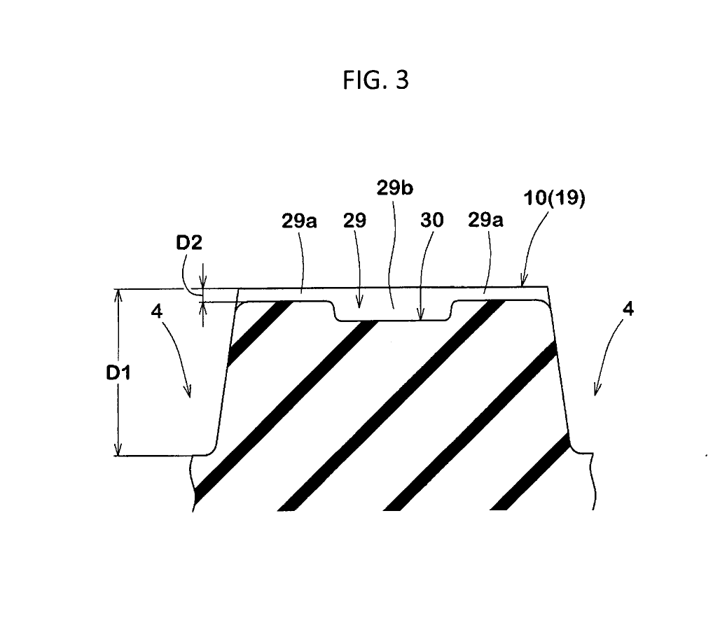

FIG. 3 shows a cross-sectional view taken at (B-B) in FIG. 2. As shown in FIG. 3, groove depth (D2) of thin groove 29 is preferred to be smaller than the groove depth of crown lateral groove 15 in order to prevent an excessive drop in the rigidity of crown block 19. In a more preferred embodiment, groove depth (D2) of thin groove 29 is set in a range of 1.0˜5.0 mm, for example.

In an even more preferred embodiment, thin-groove sipe 30 extending along thin groove 29 is formed on the bottom of thin groove 29 as shown in FIG. 1 or 2. Both ends of thin-groove sipe 30 are located inside crown block 19. Thin-groove sipe 30 is preferred to be formed at least in the central portion. More preferably, it is formed to be an approximate Z shape that bends to have two corners. Such a thin-groove sipe 30 works for crown block 19 to maintain rigidity at its edges while further mitigating rigidity in its central portion.

Groove periphery 6 of crown main groove 4 on the middle block 20 side and groove periphery 6 of middle main groove 5 on the middle block 20 side are each provided with alternately positioned inward crest (6a) protruding into middle block 20 and outward crest (6b) protruding in the opposite direction of middle block 20. Middle lateral groove 16 extends in a straight line to connect inward crests (6a). Accordingly, the ground-contact surface of middle block 20 is also formed to be approximately hexagonal. Middle lateral groove 16 and middle block 20 are structured to be the same as crown lateral groove 15 and crown block 19 respectively. Therefore, the same effects as described in crown land portion 10 are expected in middle land portion 11 as well.

Shoulder land portion 12 is preferred to have multiple shallow grooves 32 which extend from tread edge (Te) in a tire axially inward direction, for example. Shallow grooves 32 are effective for enhancing water drainage and suppressing uneven wear of tread edge (Te). Shallow grooves 32 are more preferred to be formed at the same pitch as zigzag pitch (P) of middle main groove 5. In an even more preferred embodiment, shallow grooves 32 are preferred to be where middle lateral grooves 16 are projected toward the tire axially outer side. By so setting, shallow grooves 32 are capable of efficiently draining water from middle lateral grooves 16 to the outer side.

So far, preferred embodiments of the present invention have been described. However, the present invention is not limited to those, and various modifications are possible.

### EXAMPLES

Test tires (size: 295/75R22.5) were each prepared to have basic patterns as shown in FIG. 1 and specifications as listed in Table 1. Performances of each tire were tested. Test methods are as follows.

### Wear Resistance

Test tires were mounted on all wheels of a test vehicle under the conditions below and the vehicle ran 10000 km on a dry asphalt road surface. Then, the block height was measured at three spots on a tire circumference, and the average value of maximum wear was calculated. The evaluation is shown as an index obtained by inverting the calculated value and by converting the result based on the value obtained in Example 1 being set as 100. The greater the value is, the less the uneven wear is, and it indicates a better tire.

rim: 8.25×22.5

inflation pressure: 900 kPa

### Rolling Resistance

Using a rolling resistance test machine, rolling resistance was measured when test tires were run on a drum at 80 km/hr. under the following conditions. The evaluation is shown as an index obtained by inverting the calculated value and converting the result based on the value obtained in Example 1 being set as 100. The greater the value is, the lower the rolling resistance is, and it indicates a better tire.

rim: 9.00×22.5

inflation pressure: 900 kPa

vertical load: 28.76 kN

### Noise Performance

The above vehicle with test tires mounted on all of its wheels was run at 70 km/hr. on a road noise measuring course (dry asphalt roughened road) and external vehicle noise was measured using a noise tester set on the road noise measuring course. The evaluation is shown as an index obtained by inverting the calculated value and by converting the result based on the value obtained in Example 1 being set as 100. The greater the value is, the lower the noise level is, and it indicates a better tire.

TABLE 1

| | Comp. | | | | Comp. | Comp. | | | Comp. | | |
|---|---|---|---|---|---|---|---|---|---|---|---|
| | Exam- | Exam- | Exam- | Exam- | Exam- | Exam- | Exam- | Exam- | Exam- | Exam- | Exam- |
| | ple 1 | ple 1 | ple 2 | ple 3 | ple 2 | ple 3 | ple 4 | ple 5 | ple 4 | ple 6 | ple 7 |
| Angle (α) of lateral | 5 | 15 | 10 | 20 | 25 | 15 | 15 | 15 | 15 | 15 | 15 |
| groove (degree) | | | | | | | | | | | |
| Block minimum width W2/ | 0.89 | 0.89 | 0.89 | 0.89 | 0.89 | 0.80 | 0.85 | 0.95 | 0.98 | 0.89 | 0.89 |
| Block maximum width W1 | | | | | | | | | | | |
| (ratio) | | | | | | | | | | | |
| Block maximum width W1/ | 0.90 | 0.90 | 0.90 | 0.90 | 0.90 | 0.90 | 0.90 | 0.90 | 0.90 | 0.85 | 0.95 |
| Block circumferential | | | | | | | | | | | |
| length BL (ratio) | | | | | | | | | | | |
| Wear resistance (index) | 100 | 100 | 100 | 85 | 75 | 85 | 90 | 100 | 100 | 100 | 100 |
| [greater the better] | | | | | | | | | | | |
| Rolling resistance (index) | 100 | 100 | 100 | 100 | 100 | 100 | 100 | 90 | 85 | 95 | 95 |
| [greater the better] | | | | | | | | | | | |
| Noise performance (index) | 75 | 100 | 85 | 100 | 100 | 100 | 100 | 100 | 100 | 100 | 100 |
| [greater the better] | | | | | | | | | | | |

As shown in Table 1, it is confirmed that tires in the examples are capable of improving rolling resistance and suppressing noise.

Blocks have a greater rigidity on both edges in a tire circumferential direction. Thus, both edges may cause greater impact noise when the tire makes contact with the ground during its run.

Such impact noise may be suppressed by, for example, increasing the inclination angle of lateral grooves with respect to a tire axial direction so that the timing of ground contact is staggered for either edge of a block. However, both edges of such a block deform significantly when they make contact with the ground, and traction performance and rolling resistance may thereby be degraded.

A heavy-duty pneumatic tire according to an embodiment of the present invention is capable of suppressing noise and exhibits improved traction performance and rolling resistance.

In a heavy-duty pneumatic tire according to one aspect of the present invention, the tread section has at least two main grooves in a zigzag pattern extending continuously in a tire circumferential direction and multiple lateral grooves connecting the main grooves so that the portion between the main grooves is divided into multiple blocks. A groove periphery of each main groove on a block side alternately includes an inward crest protruding toward the block side and an outward crest protruding in the opposite direction of the block. The lateral grooves connect inward crests and incline at an angle (α) in a range of 10˜20 degrees with respect to a tire axial direction; and the blocks are each formed to have an approximately hexagonal ground-contact surface; tire axial minimum width (W2) and tire axial maximum width (W1) of the ground-contact surface of a block are set to have a ratio (W2/W1) in a range of 0.85˜0.95.

In a heavy-duty pneumatic tire according to an embodiment of the present invention, the groove periphery of the main groove includes a first inclined piece extending between an outward crest and the inward crest on one side and a second inclined piece extending between the outward crest and the inward crest on the other side. Tire circumferential length (L1) of the first inclined piece and tire circumferential length (L2) of the second inclined piece are preferred to have a ratio (L1/L2) in a range of 0.97˜1.03.

In a heavy-duty pneumatic tire according to an embodiment of the present invention, a block is preferred to have a thin groove that completely crosses the ground-contact surface, and the depth of the thin groove is preferred to be smaller than that of the lateral groove.

In a heavy-duty pneumatic tire according to an embodiment of the present invention, both ends of the thin groove are each preferred to be connected to an outward crest of the main groove.

In a heavy-duty pneumatic tire according to an embodiment of the present invention, the thin groove is preferred to be in an approximate Z shape bent to have two corners.

In a heavy-duty pneumatic tire according to an embodiment of the present invention, a thin-groove sipe is preferred to be formed on the bottom of the thin groove to be parallel to the thin groove.

In a heavy-duty pneumatic tire according to an embodiment of the present invention, tire circumferential length (BL) of the ground-contact surface of the block is preferred to be 0.80˜0.90 times the zigzag pitch (P) that is the tire circumferential distance between the inward crests adjacent to each other in a tire circumferential direction.

In a heavy-duty pneumatic tire according to an embodiment of the present invention, the maximum width (W1) and tire circumferential length (BL) in the ground-contact surface of the block are preferred to have a ratio (W1/BL) in a range of 0.85˜0.95.

In a heavy-duty pneumatic tire according to an embodiment of the present invention, the main grooves include a pair of crown main grooves respectively extending on both sides of the tire equator and a pair of middle main grooves respectively extending on tire axially outer sides of the crown main grooves. The blocks each having a ground-contact surface of approximate hexagonal shape are positioned between the crown main grooves or between a crown main groove and a middle main groove. A shoulder land portion positioned on the tire axially outer side of a middle main groove is preferred to be a rib continuously extending in a tire circumferential direction.

In a heavy-duty pneumatic tire according to an embodiment of the present invention, the lateral groove is preferred to have a shallow-bottom portion raised from the bottom of the lateral groove, and the shallow-bottom portion is preferred to have a lateral-groove sipe extending in a longitudinal direction of the lateral groove.

The tread section of a heavy-duty pneumatic tire according to an embodiment of the present invention is provided with multiple lateral grooves connecting the inward crests of main grooves. Thus, the portion between main grooves is divided into multiple blocks each having a ground-contact surface in an approximate hexagonal shape. Since such a block has a tire axial width that decreases toward both sides in a tire circumferential direction, the rigidity at both tire circumferential edges is low. As a result, impact noise generated at both edges is reduced when each block makes contact with the ground. On the other hand, since the block has greater rigidity in the tire circumferential central portion than at both edges, deformation during ground contact is lessened. Accordingly, traction performance and rolling resistance are improved.

In addition, tire axial minimum width (W2) and tire axial maximum width (W1) of the ground-contact surface of a block are set to have a ratio (W2/W1) in a range of 0.85˜0.95. Thus, excessive deformation at both edges is even more certainly prevented when the block makes contact with the ground. Accordingly, even better rigidity balance is achieved, and traction performance and rolling resistance are improved.

Moreover, the lateral groove is inclined at an angle (α) in a range of 10˜20 degrees with respect to a tire axial direction. Blocks divided by such lateral grooves are capable of dispersing noise by staggering the timing of ground contact for both edges, while even further suppressing excessive deformation at both edges of each block.

Accordingly, a heavy-duty pneumatic tire according to an embodiment of the present invention is capable of reducing impact noise generated when each block makes contact with the ground, and exhibits excellent traction performance and rolling resistance.

Obviously, numerous modifications and variations of the present invention are possible in light of the above teachings. It is therefore to be understood that within the scope of the appended claims, the invention may be practiced otherwise than as specifically described herein.

What is claimed is:

1. A heavy-duty pneumatic tire, comprising:
a tread having a plurality of main grooves and a plurality of lateral grooves connecting the main grooves such that each of the main grooves has a zigzag pattern extending continuously in a tire circumferential direction and that the lateral grooves divide a portion between the main grooves into a plurality of blocks,
wherein each of the main grooves has a groove periphery on a block side such that the groove periphery has a plurality of inward crests protruding toward the block side and a plurality of outward crests protruding in an opposite direction of the blocks and alternating with the inward crests, the lateral grooves connect the inward crests and incline at an angle α in a range of 10 to 20 degrees with respect to a tire axial direction, each of the blocks is formed to have a ground-contact surface which has substantially a hexagonal shape and a ratio W2/W1 in a range of 0.85 to 0.95 where W2 represents a tire axial minimum width and W1 represents a tire axial maximum width in the ground-contact surface.

2. The heavy-duty pneumatic tire according to claim 1, wherein the groove periphery of each of the main grooves includes a plurality of first inclined pieces extending between the outward crests and the inward crests on one side and a plurality of second inclined pieces extending between the outward crests and the inward crests on the other side such that a ratio L1/L2 is set in a range of 0.97 to 1.03 where L1 represents a tire circumferential length of each of the first inclined pieces and L2 represents a tire circumferential length of each of the second inclined pieces.

3. The heavy-duty pneumatic tire according to claim 1, wherein each of the blocks has a thin groove entirely crossing the ground-contact surface and having a depth which is set smaller than a depth of each of the lateral grooves.

4. The heavy-duty pneumatic tire according to claim 3, wherein the thin groove has ends connected to the outward crests of the main grooves.

5. The heavy-duty pneumatic tire according to claim 3, wherein the thin groove is formed to have substantially in a Z shape bent to have two corners.

6. The heavy-duty pneumatic tire according to claim 3, wherein the thin groove has a thin-groove sipe formed on a bottom portion of the thin groove in parallel to the thin groove.

7. The heavy-duty pneumatic tire according to claim 1, wherein the ground-contact surface of each of the blocks has a tire circumferential length BL of which is set in a range of 0.80 to 0.90 times a zigzag pitch P that is a tire circumferential distance between the inward crests adjacent to each other in the tire circumferential direction.

8. The heavy-duty pneumatic tire according to claim 1, wherein the ground-contact surface of each of the blocks has a ratio W1/BL in a range of 0.85 to 0.95 where BL represents a tire circumferential length.

9. The heavy-duty pneumatic tire according to claim 1, wherein the plurality of main grooves comprises a pair of crown main grooves extending on both sides of a tire equator respectively and a pair of middle main grooves extending on a tire axially outer side of the crown main grooves respectively, the ground-contact surface of each of the blocks is positioned between the crown main grooves or between one of the crown main grooves and one of the middle main grooves, and the middle main grooves have shoulder land portions which are positioned on a tire axially outer side of the middle main grooves and comprise ribs continuously extending in the tire circumferential direction respectively.

10. The heavy-duty pneumatic tire according to claim 1, wherein the lateral grooves have shallow-bottom portions raised from bottom portions of the lateral grooves respectively, and the shallow-bottom portions have lateral-groove sipes extending in a longitudinal direction of the lateral grooves respectively.

11. The heavy-duty pneumatic tire according to claim 2, wherein each of the blocks has a thin groove entirely crossing the ground-contact surface and having a depth which is set smaller than a depth of each of the lateral grooves.

12. The heavy-duty pneumatic tire according to claim 11, wherein the thin groove has ends connected to the outward crests of the main grooves.

13. The heavy-duty pneumatic tire according to claim 11, wherein the thin groove is formed to have substantially in a Z shape bent to have two corners.

14. The heavy-duty pneumatic tire according to claim 11, wherein the thin groove has a thin-groove sipe formed on a bottom portion of the thin groove in parallel to the thin groove.

15. The heavy-duty pneumatic tire according to claim 2, wherein the ground-contact surface of each of the blocks has a tire circumferential length BL of which is set in a range of 0.80 to 0.90 times a zigzag pitch P that is a tire circumferential distance between the inward crests adjacent to each other in the tire circumferential direction.

16. The heavy-duty pneumatic tire according to claim 2, wherein the ground-contact surface of each of the blocks has a ratio W1/BL in a range of 0.85 to 0.95 where BL represents a tire circumferential length.

17. The heavy-duty pneumatic tire according to claim 2, wherein the plurality of main grooves comprises a pair of crown main grooves extending on both sides of a tire equator respectively and a pair of middle main grooves extending on a tire axially outer side of the crown main grooves respectively, the ground-contact surface of each of the blocks is positioned between the crown main grooves or between one of the crown main grooves and one of the middle main grooves, and the middle main grooves have shoulder land portions which are positioned on a tire axially outer side of the middle main grooves and comprise ribs continuously extending in the tire circumferential direction respectively.

18. The heavy-duty pneumatic tire according to claim 2, wherein the lateral grooves have shallow-bottom portions raised from bottom portions of the lateral grooves respectively, and the shallow-bottom portions have lateral-groove sipes extending in a longitudinal direction of the lateral grooves respectively.

19. The heavy-duty pneumatic tire according to claim 3, wherein the ground-contact surface of each of the blocks has a tire circumferential length BL of which is set in a range of 0.80 to 0.90 times a zigzag pitch P that is a tire circumferential distance between the inward crests adjacent to each other in the tire circumferential direction.

20. The heavy-duty pneumatic tire according to claim 3, wherein the ground-contact surface of each of the blocks has a ratio W1/BL in a range of 0.85 to 0.95 where BL represents a tire circumferential length.
